(19) United States
(12) Patent Application Publication
(10) Pub. No.: US 2019/0261704 A1
(43) Pub. Date: Aug. 29, 2019

(54) All-Weather Comfort Control System for Riders of an Open-Air Vehicle

(71) Applicants: Robert Bosch LLC, Broadview, IL (US); Robert Bosch GmbH, Stuttgart (DE)

(72) Inventors: Mark Sonnenberg, Grand Blanc, MI (US); Ben Lockhart, South Lyon, MI (US)

(21) Appl. No.: 16/281,387

(22) Filed: Feb. 21, 2019

Related U.S. Application Data
(60) Provisional application No. 62/635,784, filed on Feb. 27, 2018.

(51) Int. Cl. A41D 13/005; B62J 33/00; A42B 3/28

(52) U.S. Cl. CPC A41D 13/0051; A42B 3/285; B62J 33/00; A41D 13/0053

(57) ABSTRACT

An all-weather comfort-control suit operable to permit a rider of an open-air vehicle to heat or cool their body to a comfortable level. The suit may comprise a number of independent temperature zones that may be heated or cooled based upon different conditions specified by the rider and in response to temperatures measured by a number of temperature sensors. The suit may comprise a modular design permitting riders to selectively utilize individual pieces of attire that are desired. The suit may further provide protection to the rider from injury or the environment.

### TECHNICAL FIELD

This disclosure relates to motorsport vehicles, recreational motor vehicles, and safety equipment worn by riders of motorsport vehicle and recreational motor vehicles.

### BACKGROUND

Motorsport vehicles may be operated in a wide variety of weather conditions. In particular, riders of open-air vehicles such as motorcycles or off-road vehicles may be confronted with uncomfortably hot weather, cold weather, and precipitation. Conventional solutions typically require riders to purchase special-purpose safety equipment better suited to warmer or colder weather. Multi-day or long rides may be especially prone to challenging conditions as weather changes over the course of a day or across long distances. For example, a rider may dress warmly early in the day when the weather is mild, but as the ride progresses and the temperature increases, the rider may become uncomfortable in warmer equipment. In particularly hot conditions, the rider may be uncomfortably warm in even the lightest safety equipment.

It is therefore desirable to improve upon the existing safety solutions with a set of safety equipment for an open-air vehicle rider that comprises temperature-control controllable by the rider to maximize comfort while riding. Advantageously, a temperature-controlled set of safety equipment would maximize rider comfort and also eliminate the need for a rider to purchase a variety of safety equipment to accommodate different weather conditions.

### SUMMARY

One aspect of this disclosure is directed to a temperature-control system to maximize comfort for a rider of an open-air motor vehicle comprising a set of attire having a number of temperature sensors, heaters, and chillers disposed within the attire. The temperature sensors, heaters, and chillers may be in data communication with a control processor that may be controlled via a user interface. The system may be configured to operate in tandem with the operation of the vehicle.

Another aspect of this disclosure is directed to a temperature-controlled wearable apparatus usable as attire by a passenger of an open-air vehicle. The apparatus may comprise a number of heaters disposed within the apparatus and operated using a heating mesh connected to an external heat source. The apparatus may further comprise a number of chillers disposed within the apparatus and operated using a chilling mesh connected to an external cold source. The apparatus may further comprise a controller connection operable to connect to a controller configured to operate the heaters and chillers of the apparatus.

A further aspect of this disclosure is directed to a temperature-control system comprising an open-air motor vehicle, a heat source disposed within the motor vehicle, a cold source disposed within the motor vehicle, a number of wearable coverings comprising a heating mesh connected to the heat source and a chilling mesh connected to the cold source, and control components comprising a control processor and a user interface operable for a user to control the temperature-control system.

### BRIEF DESCRIPTION OF THE DRAWINGS

FIG. 1 is an illustration of a first temperature-control system.

FIG. 2 is an illustration of a second temperature-control system.

FIG. 3A is a first diagrammatic illustration from a first angle of a comprehensive temperature-controlled wearable apparatus for a passenger of an open-air vehicle.

FIG. 3B is a second diagrammatic illustration from a second angle of a comprehensive temperature-controlled wearable apparatus for a passenger of an open-air vehicle.

FIG. 4A is a first diagrammatic illustration from a first angle of a modular temperature-controlled wearable apparatus for a passenger of an open-air vehicle.

FIG. 4B is a second diagrammatic illustration from a second angle of a modular temperature-controlled wearable apparatus for a passenger of an open-air vehicle.

### DETAILED DESCRIPTION

The illustrated embodiments are disclosed with reference to the drawings. However, it is to be understood that the disclosed embodiments are intended to be merely examples that may be embodied in various and alternative forms. The figures are not necessarily to scale and some features may be exaggerated or minimized to show details of particular components. The specific structural and functional details disclosed are not to be interpreted as limiting, but as a representative basis for teaching one skilled in the art how to practice the disclosed concepts.

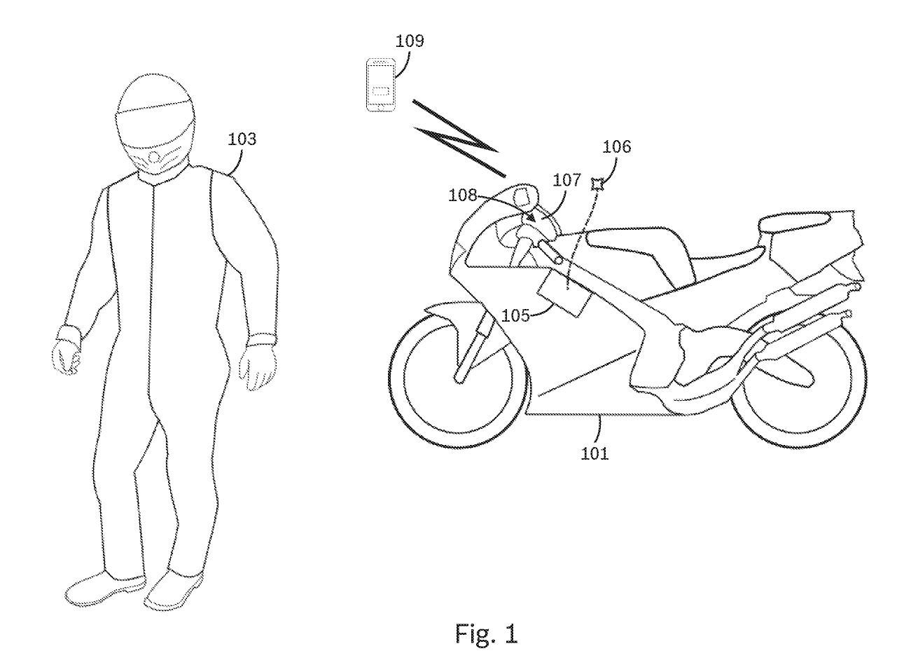

FIG. 1 illustrates a first embodiment of a temperature-control system for a rider of an open-air vehicle. In the depicted embodiment, the open-air vehicle comprises a motorcycle 101, but other embodiments may comprise other vehicle types without deviating from the teachings disclosed herein. In the depicted embodiment, the rider of the motorcycle 101 is equipped with a wearable apparatus 103. In the depicted embodiment, the wearable apparatus 103 comprises a comprehensive apparatus that includes a single-piece protective suit, helmet, gloves, and boots, but other embodiments may comprise other configurations without deviating from the teachings disclosed herein. The wearable apparatus 103 may provide conventional protections to the rider from collision, impacts, or abrasions. In some embodiments, wearable apparatus 103 may be weatherproof and provide one or more of a waterproof exterior to keep the wearer and internal portions of wearable apparatus 103 dry, windproof to protect the wearer from windburn or wind chill, or ultraviolet (UV) protection to protect the wearer from sunburn.

In the depicted embodiment, motorcycle 101 comprises a temperature source 105 that is operable to interconnect with wearable apparatus 103 via a connection. In the depicted embodiment, temperature source 105 is operable to provide a heat source and a cold source, but other embodiments may comprise other configurations without deviating from the teachings disclosed herein. Temperature source 105 is operable to provide heat and cold to wearable apparatus 103 via a combined connector 106. In the depicted embodiment, combined connector 106 comprises distinct lines to provide heat and cold to wearable apparatus 103, but other embodiments may comprise separate connections for each. In the depicted embodiment, combined connector 106 comprises a data communication line to control the heating and cooling of wearable apparatus 103, but other embodiments may comprise a distinct line for data communication.

In the depicted embodiment, combined connector 106 comprises a connector with a hardline connection to temperature sources 105. In some embodiments, motorcycle 101 may comprise a plurality of temperature sources 105, each having a distinct combined connector 106 to accommodate a plurality of riders. In some embodiments, a single temperature source 105 may comprise a plurality of combined connector 106 to accommodate a plurality of riders. In the depicted embodiment, temperature source 105 and combined connector 106 are disposed upon motorcycle 101 such that combined connector 106 may conveniently connect to wearable apparatus 103 on the left-hand side of a driver of the vehicle, but other embodiments may comprise other positions without deviating from the teachings disclosed herein.

The functions of wearable apparatus 103 and temperature source 105 may be controlled by a controller 107. In the depicted embodiment, controller 107 comprises a control processor 108, but other embodiments may comprise a general-purpose processor having software executing software instructions, firmware implementations, a field-programmable gate array (FPGA), or any other equivalent controller implementation known to one of ordinary skill in the art.

A user may control the functions of controller 107 using an interface unit 109. In the depicted embodiment, interface unit 109 comprises a portable processing device in wireless data communication with controller 107. Interface unit 109 may comprise a smart phone, tablet processor, personal digital assistant (PDA), specialized processing device, specialized controller device, smart watch, wearable processor, or any other alternative equivalent embodiment known to one of ordinary skill in the art without deviating from the teachings disclosed herein. Other embodiments may comprise other configurations. In some embodiments, interface unit 109 may comprise a wired connection to controller 107. In some embodiments, interface unit 109 may comprise a console within vehicle 101, a display housed within a head unit of vehicle 101, a proprietary wired connection between a portable device and controller 107, or any other equivalent configuration known to one of ordinary skill in the art without deviating from the teachings disclosed herein. In some embodiments, controller 107 may be configured as an external device in wired or wireless data communication with temperature source 105. In some embodiments, controller 107 and interface unit 109 may be encapsulated within a single device, such as a smart phone or tablet processor. Other embodiments may comprise other configurations without deviating from the teachings disclosed herein.

Controller 107 may be operable to adjust the flow of heat or cold from temperature source 105 to various points upon wearable apparatus 103 according to user-adjustable settings and in response to measurements from the temperature sensors. For example, temperature sensors disposed at various zones within wearable apparatus 103 may provide controller 107 with temperature measurements of each zone. If the temperatures measured in a zone are above an upper threshold value, controller 107 may transfer cold from temperature source 105 to the affected zone. If the temperatures measured in a zone are below a lower threshold value, controller 107 may transfer heat from temperature source 105 to the affected zone.

In the depicted embodiment, each zone may comprise a different user-definable upper threshold temperature and lower threshold temperature. Acceptable temperature range definitions for each temperature zone may be set to default values, or the rider may enter their preferences using interface unit 109. User-customizable temperature ranges for each temperature zone of wearable apparatus 103 may advantageously enable a user to optimize their own personal comfort for the duration of a ride. For example, the rider's seat or legs may be too warm while riding motorcycle 101 because of proximity to the heat of the engine, whereas the rider's hands may be too cold while riding because of cooler environmental temperatures and wind chill. Enabling separate temperature ranges for each of these different zones within wearable apparatus 103 may advantageously maximize a user's comfort level during a ride. Other embodiments may comprise different temperature-control schema without deviating from the teachings disclosed herein.

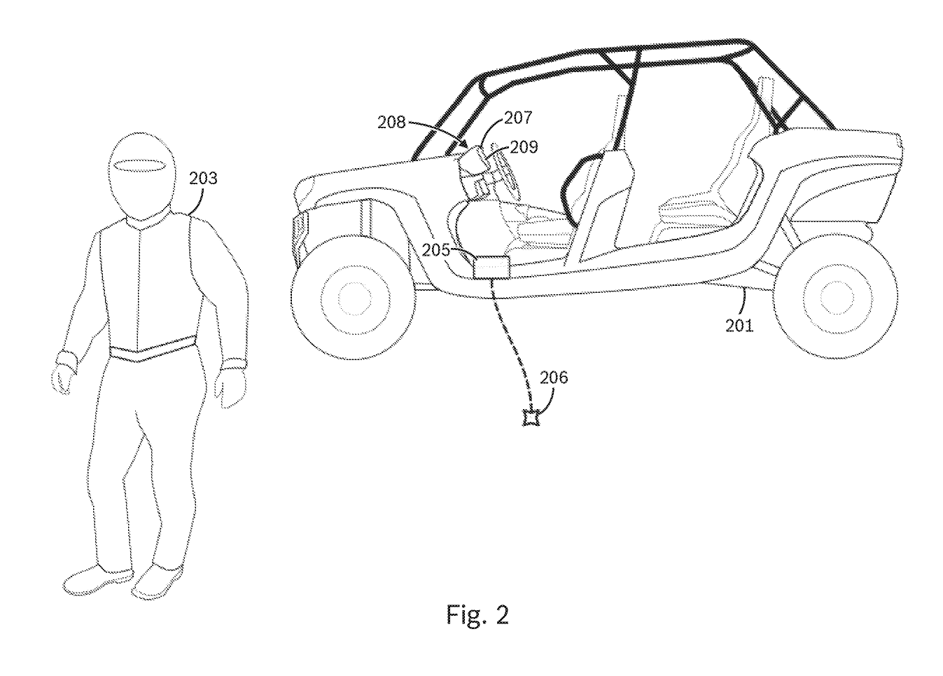

FIG. 2 illustrates a second embodiment of a temperature-control system for a rider of an open-air vehicle. In the depicted embodiment, the open-air vehicle comprises an off-highway utility vehicle (OHUV) 201 with a side-by-side seating arrangement, but other embodiments may comprise other vehicle types without deviating from the teachings disclosed herein. In the depicted embodiment, the rider of the OHUV 201 is equipped with a wearable apparatus 203. In the depicted embodiment, the wearable apparatus 203 comprises a modular, multi-piece apparatus that includes a protective jacket, pants, balaclava, gloves, and boots, but other embodiments may comprise other configurations without deviating from the teachings disclosed herein. The wearable apparatus 203 may provide conventional protections to the rider from collision, impacts, or abrasions. In some embodiments, wearable apparatus 203 may be weatherproof and provide one or more of a waterproof exterior to keep the wearer and internal portions of wearable apparatus 203 dry, windproof to protect the wearer from windburn or wind chill, or ultraviolet (UV) protection to protect the wearer from sunburn.

In some embodiments, wearable apparatus 203 may comprise additional or other pieces of wearable attire. Such attire may comprise some combination of a helmet, hat, scarf, gorget, jacket, vest, shirt, arm sleeves, pants, seat covers, leggings, chaps, boots, shoes, gloves, mittens, overalls, or a single jumpsuit covering some or all of the body of the rider. The individual pieces of wearable apparatus 203 may comprise a modular design permitting interconnection of each piece. Advantageously, a rider may choose to wear only the pieces desired for protection when riding a particular open-air vehicle. For example, if the riders in OHUV 201 may not need or desire boots, and thus may choose to wear conventional shoes or boots while operating OHUV 201, but may choose to utilize boots when operating motorcycle 101 for safety purposes. In a further advantage, a multi-piece wearable apparatus 203 allows a rider to purchase each piece of the apparatus as needed, depending on ride conditions and the particular vehicle of operation. Piecemeal acquisition of wearable apparatus 203 may permit a rider to best customize the wearable apparatus 203 to a desired activity, or to more easily manage the initial costs of purchasing the equipment. Additional functions and features of a wearable apparatus 203 will be discussed below with respect to one or more other drawings of this disclosure.

In the depicted embodiment of FIG. 2, OHUV 201 comprises a temperature source 205 that is operable to interconnect with wearable apparatus 203 via a connection. In the depicted embodiment, temperature source 205 is operable to provide a heat source and a cold source, but other embodiments may comprise other configurations without deviating from the teachings disclosed herein. Temperature source 205 is operable to provide heat and cold to wearable apparatus 203 via a combined connector 206. In the depicted embodiment, combined connector 206 comprises distinct lines to provide heat and cold to wearable apparatus 203, but other embodiments may comprise separate connections for each. In the depicted embodiment, combined connector 206 comprises a data communication line to control the heating and cooling of wearable apparatus 203, but other embodiments may comprise a distinct line for data communication.

In the depicted embodiment, combined connector 206 comprises a connector with a hardline connection to temperature sources 205. In some embodiments, OHUV 201 may comprise a plurality of temperature sources 205, each having a distinct combined connector 206 to accommodate a plurality of riders. In some embodiments, a single temperature source 205 may comprise a plurality of combined connectors 206 to accommodate a plurality of riders. In the depicted embodiment, temperature source 205 and combined connector 206 are disposed upon OHUV 201 such that combined connector 206 may conveniently connect to wearable apparatus 203 on the left-hand side of a driver of the vehicle, but other embodiments may comprise other positions without deviating from the teachings disclosed herein.

The functions of wearable apparatus 203 and temperature source 205 may be controlled by a controller 207. In the depicted embodiment, controller 207 comprises a control processor 208, but other embodiments may comprise a general-purpose processor having software executing software instructions, firmware implementations, a field-programmable gate array (FPGA), or any other equivalent controller implementation known to one of ordinary skill in the art.

A user may control the functions of controller 207 using an interface unit 209. In the depicted embodiment, interface unit 209 comprises an in-console control panel in wired communication with controller 207. Other embodiments may comprise other configurations. In some embodiments, interface unit 209 may comprise a portable wireless processor such as a smart phone, tablet processor, personal digital assistant (PDA), specialized processing device, specialized controller device, smart watch, wearable processor, or any other alternative equivalent embodiment known to one of ordinary skill in the art without deviating from the teachings disclosed herein. In some embodiments, interface unit 209 may comprise a touch-screen display within vehicle 201, a display housed within a head unit of vehicle 201, a portable device having a detachable wired connection to controller 207, or any other equivalent configuration known to one of ordinary skill in the art without deviating from the teachings disclosed herein. In some embodiments, controller 207 may be configured as an external device in wired or wireless data communication with temperature source 205. In some embodiments, controller 207 and interface unit 209 may be encapsulated within a single device, such as a smart phone or tablet processor. Other embodiments may comprise other configurations without deviating from the teachings disclosed herein.

Controller 207 may be operable to adjust the flow of heat or cold from temperature source 205 to various points within wearable apparatus 203 according to user-adjustable settings and in response to measurements from the temperature sensors. For example, temperature sensors disposed at various zones within wearable apparatus 203 may provide controller 207 with temperature measurements of each zone. If the temperatures measured in a zone are above an upper threshold value, controller 207 may transfer cold from temperature source 205 to the affected zone. If the temperatures measured in a zone are below a lower threshold value, controller 207 may transfer heat from temperature source 205 to the affected zone.

In the depicted embodiment, each zone may comprise a different user-definable upper threshold temperature and lower threshold temperature. Acceptable temperature range definitions for each temperature zone may be set to default values, or the rider may enter their preferences using interface unit 209. User-customizable temperature ranges for each temperature zone of wearable apparatus 203 may advantageously enable a user to optimize their own personal comfort for the duration of a ride. For example, the rider's seat or legs may be too warm while riding OHUV 201 because of proximity to the heat of the engine, whereas the rider's hands may be too cold while riding because of cooler environmental temperatures and wind chill. Enabling separate temperature ranges for each of these different zones within wearable apparatus 203 may advantageously maximize a user's comfort level during a ride. Other embodiments may comprise different temperature-control schema without deviating from the teachings disclosed herein.

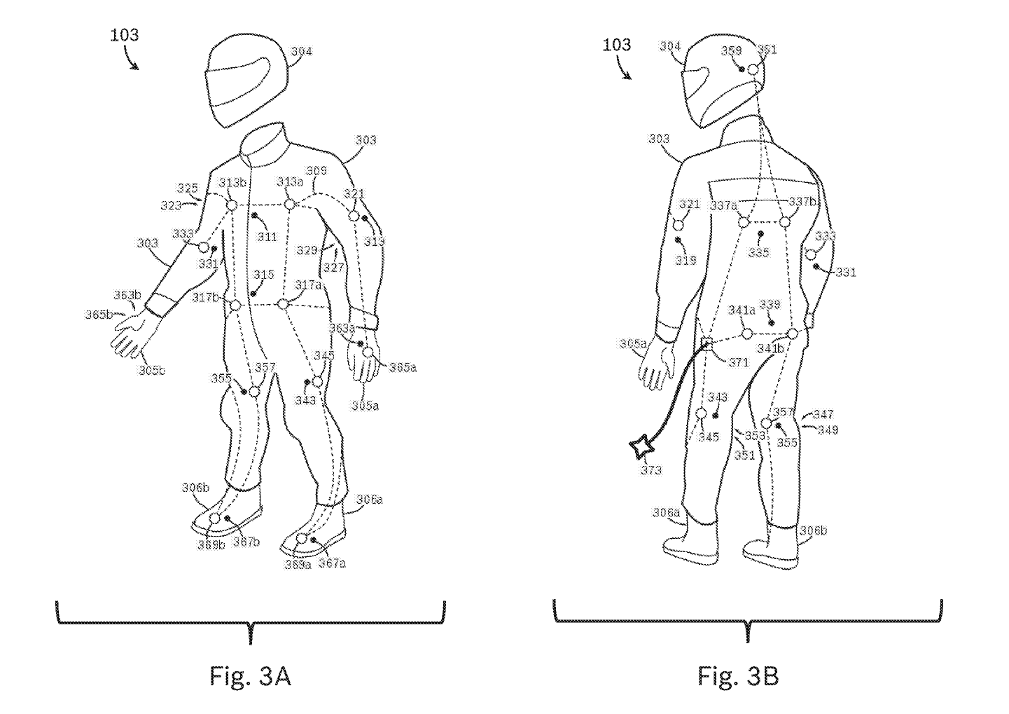

FIG. 3A and FIG. 3B provide a diagrammatic illustration of an embodiment of a wearable apparatus 103 according to one embodiment of the invention disclosed herein. FIG. 3A depicts the wearable apparatus 103 from a front angle and FIG. 3B depicts the wearable apparatus 103 from a rear angle. In the depicted embodiment, wearable apparatus comprises a jumpsuit 303, a helmet 304, a pair of gloves 305 and a pair of boots 306. Each ofjumpsuit 303, helmet 304, gloves 305, and boots 306 may comprise safety equipment providing protection to the rider in case of abrasion, impact, or collision while riding an open-air vehicle. Safety features may include structural linings or padding. Each of jumpsuit 303, helmet 304, gloves 305, and boots 306 may comprise a weatherproof construction being operable to be waterproof to keep the rider dry, windproof to protect the rider from windburn, or impervious to UV radiation to protect the rider from sunburn. Each of jumpsuit 303, helmet 304, gloves 305, and boots 306 may additionally comprise thermal insulation to protect the rider from cold temperatures. Gloves 305a and 305b are functionally similar, though glove 305a is fitted for the rider's left hand and glove 305b is fitted for the rider's right hand. Boots 306a and 306b are functionally similar, though boot 306a is fitted for the rider's left foot and boot 305b is fitted for the rider's right foot. A single-piece jumpsuit 303 may advantageously provide complete body coverage for protection.

In order to support heating and cooling functions, wearable apparatus 103 comprises a heating mesh and a chilling mesh disposed through various portions of wearable apparatus 103. In the depicted embodiment, the heating mesh and chilling mesh are disposed as a single combined mesh 309. Combined mesh 309 may comprise thermal insulation between the heating mesh and chilling mesh to optimize efficiency of the heating and cooling functions. Combined mesh 309 may additionally comprise thermal insulation to insulate the mesh components from the internal portions of wearable apparatus 103 in order to optimize the efficiency of the heating and cooling functions.

Heating functions of wearable apparatus 103 may be achieved using a number of heaters in connection with the heating mesh, each of the heaters providing heat from the heating mesh to a portion of the interior of wearable apparatus 103. In some embodiments, the heaters may comprise resistive heating elements and the heating mesh may comprise an electrical grid. In some embodiments, the heaters may comprise vents and the heating mesh may provide a conduit to channel warm air throughout wearable apparatus 103. In some embodiments, the heaters may comprise an active temperature component, and the heating mesh may comprise a conduit to direct a flow of heated coolant to particular portions of wearable apparatus 103.

Cooling functions of wearable apparatus 103 may be achieved using a number of chillers in connection with the chilling mesh, each of the chillers providing cold from the chilling mesh to a portion of the interior of wearable apparatus 103. In some embodiments, the chillers may comprise vents and the chilling mesh may provide a conduit to channel cool air throughout wearable apparatus 103. In some embodiments, the chillers may comprise an active temperature component, and the chilling mesh may comprise a conduit to direct a flow of chilled coolant to particular portions of wearable apparatus 103.

In the depicted embodiment, combined mesh 309 comprises a heating mesh comprising a conduit of warm air and a chilling mesh comprising a conduit of cold air, but other embodiments may comprise other configurations without deviating from the teachings disclosed herein.

In the depicted embodiment, a number of temperature zones are defined by the presence of a temperature sensor, a heater, and a chiller operating in a coordinated fashion. The temperature sensor of each temperature zone may be operable to measure the internal temperature of wearable apparatus 103 within a proximity corresponding to the temperature zone. The heater of each temperature zone may be operable to provide heat from the heating mesh to an interior portion of wearable apparatus 103 within a proximity corresponding to the temperature zone. The chiller of each temperature zone may be operable to provide cold from the chilling mesh to an interior portion of wearable apparatus 103 within a proximity corresponding to the temperature zone.

In the depicted embodiment, a heater and chiller may be combined into a combined heater/chiller (CHC). Each CHC disposed within wearable apparatus 103 may comprise a heater and chiller coupled in a thermally-insulated arrangement. Each heater may be operable to selectively activate and transfer heat into the temperature zone based upon a control signal. Each chiller may be operable to selectively activate and transfer cold into the temperature zone based upon a control signal. In the depicted embodiment, control signals to each heater and chiller are received through a hardwired data connection forming a control mesh that is incorporated into combined mesh 309. In some embodiments, control signals of heaters or chillers may be sent along separate independent hardwired data channels without deviating from the teachings disclosed herein. In some embodiments, control signals of heaters or chillers may be received via a wireless connection without deviating from the teachings disclosed herein.

In the depicted embodiment, a number of temperature zones may be disposed at various portions of wearable apparatus 103. A chest zone may comprise a chest sensor 311 and a number of chest CHCs 313. An abdomen zone may comprise an abdomen sensor 315 and a number of abdomen CHCs 317. A left outer-arm zone may comprise a left outer-arm sensor 319 and a left outer-arm CHC 321. A right outer-arm zone may comprise a right outer-arm sensor 323 and a right outer-arm CHC 325. A left inner-arm zone may comprise a left inner-arm temperature sensor 327 and a left inner-arm CHC 329. A right inner-arm zone may comprise a right inner-arm temperature sensor 331 and a right inner-arm CHC 333. A back zone may comprise a back temperature sensor 335 and a number of back CHCs 337. A seat zone may comprise a seat temperature sensor 339, and a number of seat CHCs 341. A left outer-leg zone may comprise a left outer-leg temperature sensor 343 and a left outer-leg CHC 345. A right outer-leg zone may comprise a right outer-leg temperature sensor 347 and a right outer-leg CHC 349. A left inner-leg zone may comprise a left inner-leg temperature sensor 351 and a left inner-leg CHC 353. A right inner-leg zone may comprise a right inner-leg temperature sensor 355 and a right inner-leg CHC 357. A helmet zone may comprise a helmet temperature sensor 359 and a helmet CHC 361. A glove zone may comprise a glove temperature sensor 363 in each glove, and a glove CHC 365 in each glove. A boots zone may comprise a boot temperature sensor 367 in each boot and a boot CHC 369 in each boot.

Some embodiments may comprise a different arrangement of temperature zones without deviating from the teachings disclosed herein. For example, in some embodiments each of gloves 305 or boots 306 may comprise individual temperature zones. In another exemplary embodiment, temperature sensors, heaters, and chillers disposed upon the arms may be coordinated as a single temperature zone. In some embodiments, some temperature zones may comprise a different number of temperature sensors. In some embodiments, some temperature zones may comprise a different number of temperature sensors, heaters or chillers. In some embodiments, some temperature zones may comprise only heaters or chillers. Some embodiments may comprise a different number or placement of temperature zones with respect to wearable apparatus 103 without deviating from the teachings disclosed herein.

In the depicted embodiment, each CHC may comprise a controllable duct to permit the flow of air from one of the heating mesh or the chilling mesh into the interior of wearable apparatus 103. Each controllable duct may comprise an electrically-controlled valve, an airflow gate, or any other equivalent configuration known to one of ordinary skill in the art without deviating from the teachings disclosed herein. In embodiments comprising an electrically-resistive heating mesh, each CHC may comprise a controllable duct to permit the flow of air from the chilling mesh, while the heating mesh operates using an electrical switch coupled to a heater comprising an electrical heating element.

Wearable apparatus 103 further comprises a mesh input port 371 which is operable to supply the combined mesh with heat from a heat source, cold from a cold source, or data from a controller (see FIG. 1). Mesh input port 371 is provided the inputs associated thereto via a combined-input connector 373 operable to receive the inputs from a compatible vehicle, such as motorcycle 101 (see FIG. 1) or OHUV 201 (see FIG. 2). In the depicted embodiment, combined-input connector 373 is configured to couple to a combined connector of a vehicle, such as combined connector 106 (see FIG. 1) or combined connector 206 (FIG. 2) and receive controller data, heat from a heat source, and cold from a cold source. In the depicted embodiment, the heat source and cold source may be combined into a temperature source, such as temperature source 105 or temperature source 205.

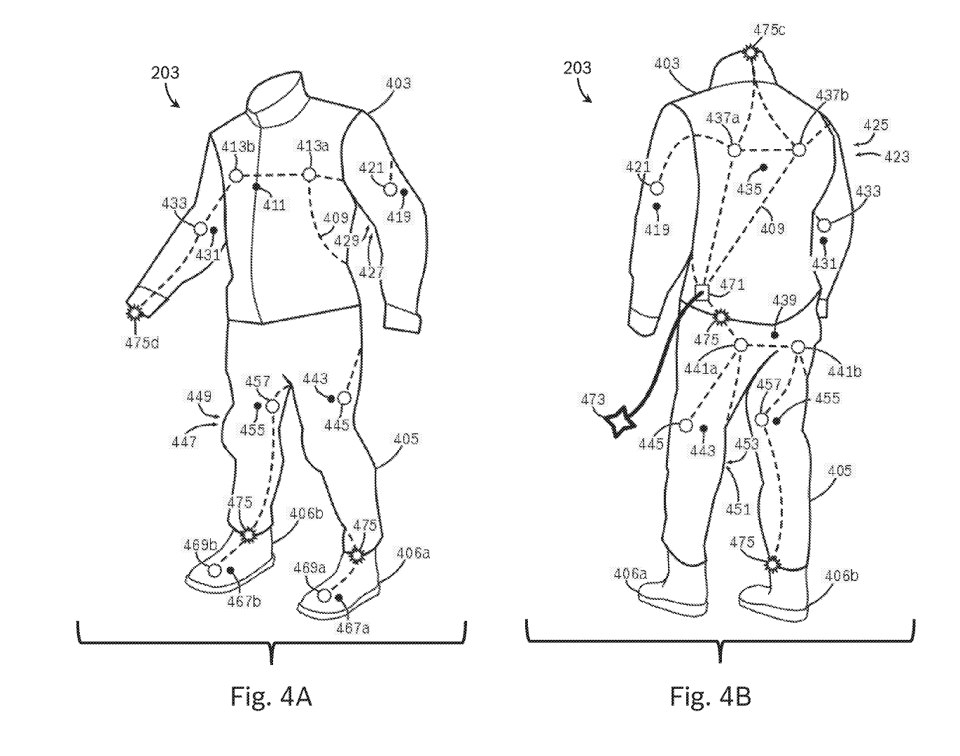

FIG. 3 depicts one embodiment of a wearable apparatus having a fully-integrated combined mesh. However, other embodiments may comprise a modular design with an expandable combined mesh that may be interconnected to other pieces of a multi-piece wearable apparatus. FIG. 4A and FIG. 4B depict the multi-piece wearable apparatus 203 (see FIG. 2) in greater detail.

Wearable apparatus 203 is depicted as comprising a jacket 403, pants 405, and boots 406, but other embodiments may comprise different or additional pieces of wearable attire without deviating from the teachings disclosed herein. Such attire may comprise some combination of a helmet, hat, scarf, gorget, jacket, vest, shirt, arm sleeves, pants, seat covers, leggings, chaps, boots, shoes, gloves, mittens, overalls, or any other piece of attire covering some or all of the body of the rider.

Wearable apparatus 203 further comprises a combined mesh 409, which may be configured in the same manner as described above with respect to combined mesh 309 (see FIG. 3). In the depicted embodiment, combined mesh 409 comprises a heating mesh, a chilling mesh, and a control mesh as described above, but other embodiments may comprise other configurations without deviating from the teachings herein.

Wearable apparatus 203 may further comprise a number of temperature zones having a temperature sensor, a heater, and a chiller in the manner described above with respect to wearable apparatus 103 (see FIG. 3). In the depicted embodiment, the temperature zones comprise at least one temperature sensor and a CHC as described above, but other embodiments may comprise other configurations without deviating from the teachings herein.

In the depicted embodiment, a number of temperature zones may be disposed at various portions of wearable apparatus 203. A chest zone may comprise a chest sensor 411 and a number of chest CHCs 413. A left outer-arm zone may comprise a left outer-arm sensor 419 and a left outer-arm CHC 421. A right outer-arm zone may comprise a right outer-arm sensor 423 and a right outer-arm CHC 425. A left inner-arm zone may comprise a left inner-arm temperature sensor 427 and a left inner-arm CHC 429. A right inner-arm zone may comprise a right inner-arm temperature sensor 431 and a right inner-arm CHC 433. A back zone may comprise a back temperature sensor 435 and a number of back CHCs 437. A seat zone may comprise a seat temperature sensor 439, and a number of seat CHCs 441. A left outer-leg zone may comprise a left outer-leg temperature sensor 443 and a left outer-leg CHC 445. A right outer-leg zone may comprise a right outer-leg temperature sensor 447 and a right outer-leg CHC 449. A left inner-leg zone may comprise a left inner-leg temperature sensor 451 and a left inner-leg CHC 453. A right inner-leg zone may comprise a right inner-leg temperature sensor 455 and a right inner-leg CHC 457. A boots zone may comprise a boot temperature sensor 467 in each boot and a boot CHC 469 in each boot.

Some embodiments may comprise additional or different temperature zones without deviating from the teachings disclosed herein. Some embodiments of wearable apparatus 203 may comprise additional pieces of attire having additional temperature zones without deviating from the teachings herein. For example, some embodiments of wearable apparatus 203 may comprise a helmet having a helmet temperature zone similar to that of wearable apparatus 103 (see FIG. 3), or a pair of gloves each having a temperature zone similar to those of wearable apparatus 103 (see FIG. 3), or additional temperature zones disposed in additional pieces of attire not described above, without deviating from the teachings disclosed herein.

Wearable apparatus 203 further comprises a mesh input port 471 which is operable to supply the combined mesh with heat from a heat source, cold from a cold source, or data from a controller (see FIG. 2). Mesh input port 471 is provided the inputs associated thereto via a combined-input connector 473 operable to receive the inputs from a compatible vehicle, such as motorcycle 101 (see FIG. 1) or OHUV 201 (see FIG. 2). In the depicted embodiment, combined-input connector 473 is configured to couple to a combined connector of a vehicle, such as combined connector 106 (see FIG. 1) or combined connector 206 (FIG. 2) and receive controller data, heat from a heat source, and cold from a cold source. In the depicted embodiment, the heat source and cold source may be combined into a temperature source, such as temperature source 105 or temperature source 205.

Because the individual pieces of attire comprising wearable apparatus 203 are separated, it may be necessary to provide connections between the combined mesh 409 of individual pieces of attire. In the depicted embodiment, the combined mesh 409 persists across pieces of attire using a number of mesh interconnects 475 disposed at various points of wearable apparatus 203. Mesh interconnects 475 may be operable to connect the components combined mesh 409, such that the control mesh, heating mesh, and chilling mesh disposed within a particular piece of attire of wearable apparatus 203 achieve the desired level of functionality. In the depicted embodiment, mesh interconnects 475 are shown to provide connectivity between the combined mesh 409 of jacket 403 and pants 405, and also between the combined mesh 409 of pants 405 with each of boots 406. In the depicted embodiment, mesh interconnects 475 that are not connected to another piece of attire may operate as a terminal for combined mesh 409, such that there is no loss of function for lack of a connection. This may advantageously provide a modular behavior to wearable apparatus 203, such that a rider may choose to utilize only pieces of attire that are desired. In the depicted embodiment, a mesh interconnect 475c is disposed to provide a potential expansion from jacket 403 to a head-covering piece of attire, and mesh interconnect 475d is disposed to provide a potential expansion from jacket 403 to a glove. Each of mesh interconnects 475c and 475d are functionally identical to the remaining mesh interconnects 475, but are actively arranged in a non-connected terminal-mode status to optimize the operation of the remaining mesh interconnects 475. Some embodiments may comprise a different number or different placement of mesh interconnects 475, including non-connected mesh interconnects 475 in a terminal-mode status, without deviating from the teachings disclosed herein.

In the depicted embodiment, the mesh interconnects 475 may comprise a compatible configuration to join with a combined connector, such as combined connector 106 (see FIG. 1) or combined connector 206 (see FIG. 2). This may advantageously enable any mesh interconnect 475 to function as a mesh input port in the same manner as mesh input port 471, or enable any individual piece of attire of wearable apparatus 203 to interface with the combined connector of a vehicle, and act as a self-contained wearable apparatus according to the teachings disclosed herein. Some embodiments may comprise an additional mesh interconnects 475 for each piece of attire within wearable apparatus for the purpose of providing an additional connection point with a combined connector. For example, a rider may choose to utilize only a jacket 403 and boots 406 as a wearable apparatus 203, each of the individual pieces of attire connecting to a separate combined connector of a vehicle. In some embodiments not having a single combined mesh 409, separate and distinct mesh interconnects may provide connections for the heating mesh, chilling mesh, or control mesh of wearable apparatus 203 without deviating from the teachings disclosed herein. In some embodiments, wearable apparatus 203 may only comprise some of control mesh, heating mesh, or chilling mesh, and have different configurations for the interconnects of the existing mesh configurations without deviating from the teachings disclosed herein.

While exemplary embodiments are described above, it is not intended that these embodiments describe all possible forms of the disclosed apparatus and method. Rather, the words used in the specification are words of description rather than limitation, and it is understood that various changes may be made without departing from the spirit and scope of the disclosure as claimed. The features of various implementing embodiments may be combined to form further embodiments of the disclosed concepts.

What is claimed is:

1. A temperature-control system for a passenger of an open-air vehicle, the system comprising:
attire wearable by the passenger;
a plurality of temperature sensors disposed within the attire, each of the temperature sensors defining a temperature zone within the attire when worn by the passenger;
a heater disposed within a temperature zone of the attire and operable to increase the temperature within the temperature zone wherein it is disposed;
a chiller disposed within a temperature zone of the attire and operable to decrease the temperature within the temperature zone wherein it is disposed;
a control processor in data communication with the plurality of temperature sensors, the heater, and the chiller, the control processor being operable to monitor the outputs of the temperature sensors and to control the functions of the heater and the chiller; and
an interface unit in data communication with the control processor and operable to permit a user to control the functions of the control processor.

2. The temperature-control system of claim 1, wherein the heater operable to be in fluid communication with a heat source disposed upon the vehicle and the heater is operable to control the flow of heat from the heat source into the temperature zone associated with the heater.

3. The temperature-control system of claim 1, wherein the heater comprises an electrically-powered heating element operable to connect to an electrical source disposed upon the vehicle.

4. The temperature-control system of claim 1, wherein the chiller is in fluid communication with a cold source disposed upon the vehicle and the chiller is operable to control the flow of cold from the cold source into the temperature zone associated with the chiller.

5. The temperature-control system of claim 1, wherein the heater is in a first fluid communication with a heat source disposed upon the vehicle and the chiller is in a second fluid communication with a cold source disposed upon the vehicle, wherein the first fluid communication and the second fluid communication are each disposed within a central connection channel.

6. The temperature-control system of claim 5, wherein the central connection channel comprises a central connector operable to pair with a central port on the vehicle, the central port providing heat from the heat source to the heater and cold from the cold source to the chiller when the central connector is coupled to the central port.

7. The temperature-control system of claim 1, wherein the interface unit comprises a portable processing device in wireless data communication with the control processor.

8. The temperature-control system of claim 7, wherein the handheld processing device comprises a smart phone.

9. The temperature-control system of claim 1, wherein the heater may be operated by the control processor independently of the chiller, and the chiller may be operated by the control processor independently of the heater.

10. The temperature-control system of claim 1, wherein the attire comprises a plurality of wearable coverings, each wearable covering comprising a temperature zone defined by a temperature sensor, a heater, and a chiller.

11. A temperature-controlled wearable apparatus usable as attire by a passenger of an open-air vehicle comprising:
a number of wearable coverings;
a plurality of temperature sensors disposed within the number of wearable coverings, each of the plurality of temperature sensors defining the focal point of a temperature zone;
a plurality of heaters disposed within the number of wearable coverings, each of the plurality of temperature zones comprising at least one heater operable to increase the temperature within the associated temperature zone;
a heating mesh providing fluid communication between the heaters and a heat-source connection, the heat-source connection being operable to transfer heat from a heat source external to the wearable apparatus to a number of the plurality of heaters;
a plurality of chillers disposed within the number of wearable coverings, each of the plurality of temperature zones comprising at least one chiller operable to decrease the temperature within the associated temperature zone;
a chilling mesh providing fluid communication between the chillers and a cold-source connection, the cold-source connection being operable to transfer cold from the cold-source connection external to the wearable apparatus to a number of the plurality of chillers; and
a controller connection providing data communication between each of the plurality of heaters and the plurality of chillers to a controlling processor operable to control the plurality of heaters and the plurality of chillers, wherein at least two of the heat-source connection, the cold-source connection, and the controller connection are disposed within a combined-connector assembly.

12. The temperature-controlled wearable apparatus of claim 11, wherein the number of wearable coverings comprise protective equipment configured to minimize injury to the passenger.

13. The temperature-controlled wearable apparatus of claim 11, wherein the exterior of the number of wearable coverings is weatherproof.

14. The temperature-controlled wearable apparatus of claim 11, comprising a plurality of wearable coverings, each of the plurality of wearable coverings comprising an interconnect assembly operable to provide fluid communication for the heating mesh and the chilling mesh between the associated wearable covering and at least one other wearable covering.

15. The temperature-controlled wearable apparatus of claim 14, wherein each of the interconnect assemblies comprises a combined-connector assembly.

16. The temperature-controlled wearable apparatus of claim 11, wherein the number of wearable coverings comprise thermal insulation operable to minimize the thermal conduction between the heating mesh, the chilling mesh and the interior of the wearable coverings.

17. A temperature-control system comprising:
an open-air motor vehicle operable to carry a number of passengers;
a heat source disposed within the motor vehicle having a heat-source output connector operable to provide fluid communication between the heat source and a connected component;
a cold source disposed within the motor vehicle having a cold-source output connector operable to provide fluid communication between the cold source and a connected component;
a number of wearable coverings comprising a heat mesh having a heat-source input connector operable to connect to the heat-source output connector, a cold mesh having a cold-source input connector operable to connect to the cold-source output connector, and a number of temperature sensors each operable to measure the temperature of an interior portion of the wearable coverings;
a control processor in data communication with the temperature sensors, the heat source, the heat mesh, the cold source, and the cold mesh, and operable to control the heat source, heat mesh, cold source, and cold mesh; and
an interface component in data communication with the control processor and operable to provide a user interface to control the functions of the control processor.

18. The temperature-control system of claim 17, wherein the cold source comprises a reservoir of coolant and is operable to charge a cold mesh connected to the cold source with coolant.

19. The temperature-control system of claim 17, wherein the heat source comprises a heat sink operable to harvest warm air from the environment surrounding an engine component of the open-air motor vehicle and the heat source is operable to charge a heat mesh connected to the heat source with warm air.

20. The temperature-control system of claim 17, wherein the control processor is operable to charge the cold mesh in response to the temperature of an interior portion of the wearable coverings rising below an upper threshold value or to charge the heat mesh in response to the temperature of an interior portion of the wearable coverings falling below a lower threshold value.
